(19) United States
(12) Patent Application Publication
(10) Pub. No.: US 2013/0032013 A1
(43) Pub. Date: Feb. 7, 2013

(54) METHOD OF MANUFACTURING GROUP III NITRIDE CRYSTAL SUBSTRATE

(71) Applicants: Hidenori MIKAMI, Itami-shi (JP); Naoki Matsumoto, Itami-shi (JP)

(72) Inventors: Hidenori MIKAMI, Itami-shi (JP); Naoki Matsumoto, Itami-shi (JP)

(73) Assignee: SUMITOMO ELECTRIC INDUSTRIES, LTD., Osaka-shi (JP)

(21) Appl. No.: 13/535,606

(22) Filed: Jun. 28, 2012

Related U.S. Application Data
(60) Provisional application No. 61/514,993, filed on Aug. 4, 2011.

(30) Foreign Application Priority Data
Aug. 4, 2011 (JP) 2011-170706

(51) Int. Cl. B26D 1/00

(52) U.S. Cl. 83/13

(57) ABSTRACT

A method of manufacturing a group III nitride crystal substrate includes the step of preparing a group III nitride crystal body and the step of producing a group III nitride crystal substrate by slicing the group III nitride crystal body with a resin-fixed-abrasive wire. Accordingly, the method of manufacturing a group III nitride crystal substrate is provided that enables large-sized group III nitride crystal substrates with a small warp and a small arithmetic mean surface roughness to be manufactured by means of a resin-fixed-abrasive wire efficiently with a high yield.

### BACKGROUND OF THE INVENTION

1. Field of the Invention

The present invention relates to a method of manufacturing a group III nitride crystal substrate using a resin-fixed-abrasive wire on which abrasive is fixed with resin.

2. Description of the Background Art

Crystal substrates are generally manufactured by slicing a crystal body grown in any of various ways. Regarding how to slice the crystal body, methods of slicing by means of a variety of saw wires have been proposed.

As to the method of slicing a crystal body with a saw wire, a method using a wire and a loose abrasive and a method using a fixed-abrasive wire with an abrasive fixed on the wire are commonly employed. For example, Japanese Patent Laying-Open No. 2006-190909 (Patent Literature 1) discloses a method of cutting a hexagonal group III nitride crystal using a wire and a loose abrasive. Japanese Patent Laying-Open No. 2011-031386 (Patent Literature 2) and Japanese Patent Laying-Open No. 2011-031387 (Patent Literature 3) disclose a method of slicing a Ga-contained nitride crystal using an electrodeposit-fixed-abrasive wire which is a kind of fixed-abrasive wire. The electrodeposit-fixed-abrasive wire is a wire on which abrasive is fixed with electrodeposit. Japanese Patent Laying-Open No. 2000-246654 (Patent Literature 4) discloses a resin-fixed-abrasive wire which is a fixed-abrasive wire for slicing a silicon wafer.

The method of slicing a group III nitride crystal body by means of a wire and a loose abrasive disclosed in Japanese Patent Laying-Open No. 2006-190909 (Patent Literature 1) requires a long time for slicing, and is therefore unfavorable for slicing a large-sized crystal body, resulting in a problem of a low yield of produced group III nitride crystal substrates.

The method of slicing a group III nitride crystal body by means of a fixed-abrasive wire disclosed in Japanese Patent Laying-Open Nos. 2011-031386 (Patent Literature 2) and 2011-031387 (Patent Literature 3) uses an electrodeposit-fixed-abrasive wire as the fixed-abrasive wire. Since the abrasive is fixed with a strong force, resultant problems are a large warp and a large surface roughness as well as a low yield of produced group III nitride crystal substrates. As for the resin-fixed-abrasive wire disclosed in Japanese Patent Laying-Open No. 2000-246654 (Patent Literature 4), the force with which the abrasive is fixed is weaker relative to the electrodeposit-fixed-abrasive wire, and thus this wire has been considered as inappropriate for slicing a hard crystal body such as group III nitride crystal body.

### SUMMARY OF THE INVENTION

An object of the present invention is to solve the problems above and provide a method of manufacturing a group III nitride crystal substrate by which large-sized group III nitride crystal substrates with a small warp and a small surface roughness can be manufactured efficiently with a high yield by means of a resin-fixed-abrasive wire.

According to an aspect of the present invention, a method of manufacturing a group III nitride crystal substrate includes the steps of preparing a group III nitride crystal body and producing a group III nitride crystal substrate by slicing the group III nitride crystal body with a resin-fixed-abrasive wire.

Regarding the method of manufacturing a group III nitride crystal substrate according to the present invention, the group III nitride crystal substrate may have a warp of 50 μm or less per 4 inches, the group III nitride crystal substrate may have an arithmetic mean surface roughness Ra of 0.5 μm or less, and yield of the group III nitride crystal substrates may be 80% or more.

In accordance with the present invention, a method of manufacturing a group III nitride crystal substrate can be provided that enables large-sized group III nitride crystal substrates with a small warp and a small arithmetic mean surface roughness to be manufactured by means of a resin-fixed-abrasive wire efficiently with a high yield.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a chart illustrating a method of manufacturing a group III nitride crystal substrate according to the present invention.

FIG. 2 is a schematic cross-sectional view showing a resin-fixed-abrasive wire used for the method of manufacturing a group III nitride crystal substrate according to the present invention.

FIG. 3 is a schematic cross-sectional view showing an electrodeposit-fixed-abrasive wire used for a typical method of manufacturing a group III nitride crystal substrate.

FIG. 4 is a schematic diagram showing one state where a saw wire is used to slice a group III nitride crystal body.

FIG. 5 is a schematic diagram showing another state where the saw wire is used to slice the group III nitride crystal body.

FIG. 6 is a schematic diagram showing still another state where the saw wire is used to slice the group III nitride crystal body.

### DESCRIPTION OF THE PREFERRED EMBODIMENTS

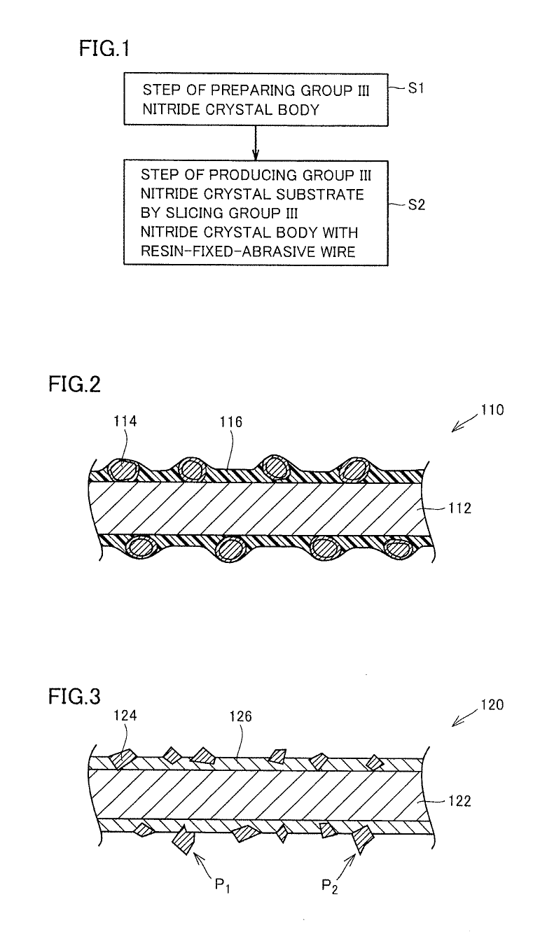

Referring to FIG. 1, a method of manufacturing a group III nitride crystal substrate in an embodiment of the present invention includes the step S1 of preparing a group III nitride crystal body, and the step S2 of producing a group III nitride crystal substrate by slicing the group III nitride crystal body with a resin-fixed-abrasive wire. In accordance with the method of manufacturing a group III nitride crystal substrate of the present embodiment, a resin-fixed-abrasive wire is used to slice a large-sized group III nitride crystal body to thereby enable large-sized group III nitride crystal substrates with a small warp and a small arithmetic mean surface roughness Ra to be manufactured efficiently with a high yield.

Step of Preparing Group III Nitride Crystal Body

Referring to FIGS. 1 and 4 to 6, the method of manufacturing a group III nitride crystal substrate of the present embodiment includes the step S1 of preparing a group III nitride crystal body 30. In the step S1 of preparing group III nitride crystal body 30, the method of producing group III nitride crystal body 30 is not particularly limited. Vapor phase methods such as HVPE (hydride vapor phase epitaxy) method, MBE (molecular beam epitaxy) method, MOVPE (metal organic vapor phase epitaxy) method, and sublimation method, liquid phase methods such as flux method and high nitrogen pressure solution method, ammonothermal growth method, and the like, are suitably used.

Step of Producing Group III Nitride Crystal Substrate

Referring to FIGS. 1, 2 and 4 to 6, the method of manufacturing a group III nitride crystal substrate of the present embodiment includes the step S2 of producing a group III nitride crystal substrate by slicing group III nitride crystal body 30 using a resin-fixed-abrasive wire 110 as a saw wire 100.

Referring to FIG. 2, resin-fixed-abrasive wire 110 used in the present embodiment is a wire including a steel wire 112 and an abrasive 114 fixed on the surface of steel wire 112 with a resin 116. Abrasive 114 is not particularly limited. In order to enhance the efficiency in slicing, abrasive 114 may preferably be diamond abrasive, green silicon carbide (green carborundum (GC)) abrasive, cubic boron nitride (CBN) abrasive or the like. While the grain size of abrasive 114 is not particularly limited, it may preferably be approximately 10 μm to 100 μm since it provides high performance in slicing. In order to enhance bonding with resin 116 and increase the force of fixing abrasive, abrasive 114 may preferably be coated with a layer of Cu, Ni, Ti, TiC or the like.

Resin 116 is not particularly limited as well. In order to provide a large force of fixing abrasive 114 on the wire as well as high performance in slicing, resin 116 may preferably be phenol resin, polyimide resin, polyamide-imide resin, polyurethane resin, polyester resin, epoxy resin or the like.

Regarding resin-fixed-abrasive wire 110, the force of fixing the abrasive to the wire is smaller than that of an electrodeposit-fixed-abrasive wire described below, and therefore, the warp and arithmetic mean surface roughness Ra of group III nitride crystal substrates obtained by slicing can be reduced and the yield of group III nitride crystal substrates can be increased.

Referring to FIG. 3, an electrodeposit-fixed-abrasive wire 120 is a wire including a steel wire 122 and an abrasive 124 fixed on the surface of steel wire 122 by electrodeposition. When abrasive 124 is to be fixed to steel wire 122, an electrodeposit layer 126 is formed. Electrodeposit layer 126 is not particularly limited as long as it can firmly fix abrasive 124 to the wire. As the electrodeposit layer, an Ni layer, Ti layer, Cu layer or the like is formed. The electrodeposit-fixed-abrasive wire 120 has a larger force of fixing abrasive 124 and includes portions P₁, P₂ that are a part of abrasive 124 protruding to a large extent from electrodeposit layer 126. Therefore, the warp and arithmetic mean surface roughness Ra of group III nitride crystal substrates obtained by slicing are large. Furthermore, cracks or the like that occur in the slicing step lowers the yield of group III nitride crystal substrates.

Referring to FIGS. 1, 2, and 4 to 6, the method of slicing group III nitride crystal body 30 using resin-fixed-abrasive wire 110 as saw wire 100 is not particularly limited. In order to efficiently slice the crystal body, a method of slicing it with a multi-wire saw may suitably be used.

The multi-wire saw includes a work support platform 11a, a work support member 11b, guide rollers 12a, 12b, 12c, and a saw wire string formed by a single saw wire 100 stretched on the rollers. These components of the multi-wire saw are each supported by a housing (not shown).

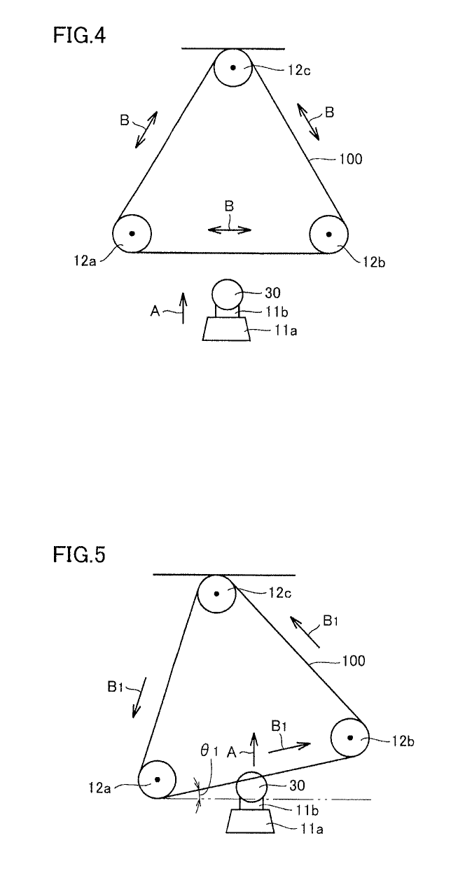

Work support platform 11a is disposed below other components. At least one group III nitride crystal body 30 is fixed above work support platform 11a with work support member 11b interposed therebetween, Work support platform 11a is mounted on a movable table (not shown), and this movable table moves vertically upward to carry group III nitride crystal body 30 vertically upward (feed direction A indicated by arrow A in FIGS. 4 to 6).

Guide rollers 12a, 12b, 12c are each a rotating body having a substantially columnar shape, and are arranged so that respective rotational axes are orthogonal to the vertical direction (feed direction A) and are parallel with each other. Guide roller 12a and guide roller 12b are arranged so that they are separated from each other on the left side and the right side with respect to an imaginary vertical line passing through work support platform 11a. Guide roller 12c is disposed above guide rollers 12a and 12b and on the imaginary vertical line passing through work support platform 11a.

On respective outer peripheral surfaces of these guide rollers 12a, 12b, 12c, a plurality of grooves are formed in parallel with each other and at regular intervals. In these grooves, a single saw wire 100 is spirally extended to form the saw wire string. Saw wire 100 is caused to reciprocate in two directions by alternately repeated positive turn and reverse turn of guide rollers 12a, 12b, 12c. Of saw wire 100 stretched on these guide rollers 12a, 12b, 12c, the portion running under guide rollers 12a and 12b runs in the position crossing group III nitride crystal body 30 which has been fed upward by movement of work support platform 11a.

Here, in order to prevent cracks from occurring to group III nitride crystal body 30 when group III nitride crystal body 30 is sliced, these guide rollers 12a, 12b, 12c swing so that the plane of the wire string of saw wire 100 that is located between guide roller 12a and guide roller 12b forms a predetermined swing angle θ₁, θ₂ with respect to the plane perpendicular to feed direction A of group III nitride crystal body 30 (the plane is hereinafter referred to as “cut plane”).

Referring to FIGS. 1, 2, and 4 to 6, the method of slicing with the multi-wire saw may for example be the following one. At least one group III nitride crystal body 30 which is a work (workpiece to be processed) is fixed on work support platform 11a with work support member 11b interposed therebetween so that a main surface of group III nitride crystal body 30 is parallel with the direction in which saw wire 100 extends (which is the same direction as direction B in which saw wire 100 (resin-fixed-abrasive wire 110 in the present embodiment) runs as indicated by arrow B in FIG. 4) and perpendicular to the plane of the wire string.

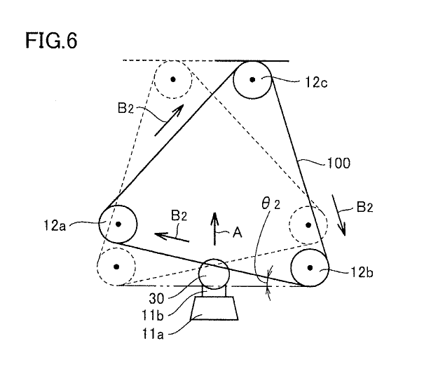

Subsequently, guide rollers 12a, 12b, 12c are swung while being turned in the positive direction (direction B₁ in FIG. 5 for example) and the reverse direction (direction B₂ in FIG. 6 for example) alternately so as to cause saw wire 100 to start swinging and reciprocating.

Then, work support platform 11a on which group III nitride crystal body 30 is fixed is moved upward to thereby feed group III nitride crystal body 30 to the saw wire string. Group III nitride crystal body 30 is brought into contact with the resin-fixed-abrasive wire which is saw wire 100, and accordingly cutting of group III nitride crystal body 30 is started.

Here, in accordance with the method of slicing in the present embodiment, it is supposed that an angle formed between the cut plane of group III nitride crystal body 30 and the direction in which the resin-fixed-abrasive wire (saw wire 100) runs vertically upward relative to the cut plane of group III nitride crystal body 30 is a positive angle. Group III nitride crystal body 30 is sliced by “swing running” of the resin-fixed-abrasive wire (saw wire 100) in which “forward-direction running” and “reverse-direction running” are repeatedly alternated with each other. Specifically, in the forward-direction running, the resin-fixed-abrasive wire (saw wire 100) is caused to run at a first swing angle θ₁ (>0) and in the forward direction (direction B₁ in FIG. 5), where the first swing angle θ₁ is an angle formed between the cut plane of group III nitride crystal body 30 and the direction in which the resin-fixed-abrasive wire (saw wire 100) runs, and the forward direction is the direction from one end of the cut plane of group III nitride crystal body 30 toward the central portion thereof. In the reverse-direction running, the resin-fixed-abrasive wire (saw wire 100) is caused to run at a second swing angle θ₂ (>0) and in the reverse direction (direction B₂ in FIG. 6), where the second swing angle θ₂ is an angle formed between the cut plane of group III nitride crystal body 30 and the direction in which the resin-fixed-abrasive wire (saw wire 100) runs, and the reverse direction is the direction from the other end of the cut plane of group III nitride crystal body 30 toward a central portion thereof.

Namely, in accordance with the method of slicing in the present embodiment, in order to allow the resin-fixed-abrasive wire (saw wire 100) to perform the swing running in the above-described manner, it is necessary to synchronize the cycle of switching the forward direction and the reverse direction of the resin-fixed-abrasive wire (saw wire 100) to each other with the cycle of swinging the resin-fixed-abrasive wire (saw wire 100). How to synchronize them is not particularly limited. For example, in synchronization with the cycle in which the resin-fixed-abrasive wire (saw wire 100) running in the forward direction is decelerated to be stopped and then switched to the reverse direction and accelerated from the stopped state; the swing angle of the resin-fixed-abrasive wire (saw wire 100) may be reduced from first swing angle θ₁ to 0° and then increased from 0° to second swing angle θ₂.

In the case where an electrodeposit-fixed-abrasive wire is used to slice group III nitride crystal body 30, the electrodeposit-fixed-abrasive wire may be used as saw wire 100 to slice group III nitride crystal body 30 in a similar manner to the above-described one. In the case where a wire on which the abrasive is not fixed and a loose abrasive are used to slice group III nitride crystal body 30, the group III nitride crystal body may be sliced in a similar manner to the above-described one, using a wire on which no abrasive is fixed as saw wire 100 and a slurry (abrasive solution) obtained by mixing the loose abrasive in a lapping oil that is jetted toward saw wire 100 and group III nitride crystal body 30 from a slurry nozzle (not shown) which is provided vertically above relative to saw wire 100 between group III nitride crystal body 30 and guide roller 12a and guide roller 12b.

Regarding the method of manufacturing a group III nitride crystal substrate in the present embodiment, the warp of the group HI nitride crystal substrate is not particularly limited. In order to obtain a group III nitride crystal substrate of high quality, the warp is preferably 50 μm or less per 4 inches (10.16 cm) and more preferably 30 μm or less per 4 inches. Here, the warp of the group III nitride crystal substrate refers to the level difference between the most convex portion and the most concave portion per 4 inches of the substrate, and is measured by means of a stylus-type surface waviness meter.

Regarding the method of manufacturing a group III nitride crystal substrate of the present embodiment, arithmetic mean surface roughness Ra of the group III nitride crystal substrate is not particularly limited. In order to obtain a group III nitride crystal substrate of high quality, the surface roughness is preferably 0.5 μm or less and more preferably 0.35 μm or less. Here, arithmetic mean surface roughness Ra of the group III nitride crystal substrate refers to arithmetic mean surface roughness Ra defined by JIS B 0601:2001, and is measured by means of a stylus-type surface waviness meter.

Regarding the method of manufacturing a group III nitride crystal substrate of the present embodiment, the yield of group III nitride crystal substrates is not particularly limited. In order to efficiently manufacture group III nitride crystal substrates, the yield is preferably 80% or more and more preferably 90% or more. Here, the yield is evaluated based on the percentage (%) of the number of group III nitride crystal substrates to which no crack has occurred, relative to the number of group III nitride crystal substrates obtained by slicing.

### Example 1

1. Preparation of Group III Nitride Crystal Body

A GaN crystal body (group III nitride crystal body) grown by the HVPE method, having a front main surface which was a Ga-atom surface ((0001) plane) and a rear main surface which was an N-atom surface ((000-1) plane), and having a diameter of 4 inches (10.16 cm) and a thickness of 2 mm to 10 mm was prepared.

2. Production of Group III Nitride Crystal Substrate

2-1. Preparation of Resin-Fixed-Abrasive Wire

Referring to FIG. 2, resin-fixed-abrasive wire 110 was prepared including steel wire 112 which was SWRS82A defined by JIS G 3502:2004 and had a diameter of 0.18 mm, and abrasive 114 which was a diamond abrasive with a grain size of 60 μm to 80 μm and fixed to steel wire 112 with resin 116 which was a phenol resin.

2-2. Slicing of Group III Nitride Crystal Body

Referring to FIGS. 4 to 6, resin-fixed-abrasive wire 110 prepared in the above-described manner was used as saw wire 100 to slice the GaN crystal body (group III nitride crystal body 30) prepared in the above-described manner and thereby produce a GaN crystal substrate (group III nitride crystal substrate) of 4 inches in diameter and 600 μm in thickness.

The crystal body was sliced under the conditions that the wire feed was 5 m/min to 20 m/min, the constant high speed at which the wire ran was 400 m/min, the time for which the constant high speed was kept was 4.5 sec, the acceleration/deceleration time (one of the time taken for acceleration from the speed zero to the constant high speed and the time taken for deceleration from the constant high speed to the speed zero) was 1.5 sec (namely the time taken for deceleration and acceleration from the constant high speed in one of the directions to the constant high speed in the opposite direction was 3.0 sec), the swing angle was 5°, the swing angular velocity was 350°/min, the tension on the wire was 35 N, and the rate at which the crystal body was sliced was 0.5 mm/hr to 6.0 mm/hr. In order to remove cutting chips and heat generated during slicing, the crystal body was sliced while a cutting fluid which was a mixture of a surfactant and water was jetted to the GaN crystal body (group III nitride crystal body) and the resin-fixed-abrasive wire.

A short time of approximately 27 hours was required for slicing one GaN crystal body (group III nitride crystal body).

Arithmetic mean surface roughness Ra of the obtained GaN crystal substrate (group III nitride crystal substrate) was measured with a stylus-type surface waviness meter (SURFCOM manufactured by Tokyo Seimitsu Co., Ltd.). In both the direction perpendicular to the direction in which the wire ran and the direction parallel to the direction in which the wire ran, the surface roughness was a small roughness of 0.2 μm to 0.35 μm.

The warp of the GaN crystal substrate (group III nitride crystal substrate) was also measured with the stylus-type surface waviness meter (SURFCOM manufactured by Tokyo Seimitsu Co., Ltd.). In both the direction perpendicular to the direction in which the wire ran and the direction parallel to the direction in which the wire ran, the warp was a small warp of 30 μm.

The yield of the GaN crystal substrates (group III nitride crystal substrates) was a high yield of 90% in percentage (%) of the number of group III nitride crystal substrates to which no crack occurred, relative to the number of group III nitride crystal substrates obtained by slicing. The results are summarized in Table 1.

### Comparative Example 1

1. Preparation of Group III Nitride Crystal Body

In a similar manner to Example 1, a GaN crystal body (group III nitride crystal body) having a front main surface which was a Ga-atom surface ((0001) plane) and a rear main surface which was an N-atom surface ((000-1) plane) and having a diameter of 4 inches (10.16 cm) and a thickness of 2 mm to 10 mm was prepared.

2. Production of Group III Nitride Crystal Substrate

2-1. Preparation of Wire and Slurry Containing Loose Abrasive

As for the wire, a steel wire which was SWRS82A defined by JIS G 3502:2004 and had a diameter of 0.18 mm was prepared. As for the slurry, a slurry containing a mineral oil used as a lapping oil and a diamond abrasive used as a loose abrasive and having a grain size of 4 μm to 8 μm was prepared.

2-2. Slicing of Group III Nitride Crystal Body

Referring to FIGS. 4 to 6, the wire prepared in the above-described manner was used as saw wire 100 to slice the GaN crystal body (group III nitride crystal body 30) prepared in the above-described manner while the slurry prepared in the above-described manner was jetted to the crystal body and the wire, and thereby produce a GaN crystal substrate (group III nitride crystal substrate) of 4 inches in diameter and 600 μm in thickness.

The crystal body was sliced under the conditions that the wire feed was 8 m/min to 10 m/min, the constant high speed at which the wire ran was 400 m/min, the time for which the constant high speed was kept was 4.5 sec, the acceleration/deceleration time was 1.5 sec, the swing angle was 0.3°, the swing angular velocity was 100°/min, the tension on the wire was 30 N, and the rate at which the crystal body was sliced was 0.5 mm/hr to 2.0 mm/hr.

A long time of approximately 160 hours was required for slicing one GaN crystal body (group III nitride crystal body). In both the direction perpendicular to the direction in which the wire ran and the direction parallel to the direction in which the wire ran, arithmetic mean surface roughness Ra of the obtained GaN crystal substrate (group III nitride crystal substrate) was a small roughness of 0.2 μm to 0.3 μm. In both the direction perpendicular to the direction in which the wire ran and the direction parallel to the direction in which the wire ran, the warp of the obtained GaN crystal substrate (group III nitride crystal substrate) was a large warp of 75 μm. The yield of GaN crystal substrates (group III nitride crystal substrates) was a low yield of 75%. The results are summarized in Table 1.

### Comparative Example 2

1. Preparation of Group III Nitride Crystal Body

In a similar manner to Example 1, a GaN crystal body (group III nitride crystal body) having a front main surface which was a Ga-atom surface ((0001) plane) and a rear main surface which was an N-atom surface ((000-1) plane) and having a diameter of 4 inches (10.16 cm) and a thickness of 2 mm to 10 mm was prepared.

2. Production of Group III Nitride Crystal Substrate

2-1. Preparation of Electrodeposit-Fixed-Abrasive Wire

Referring to FIG. 3, electrodeposit-fixed-abrasive wire 120 including steel wire 122 which was SWRS82A defined by JIS G 3502:2004 and had a diameter of 0.18 mm and abrasive 124 which was a diamond abrasive with a grain size of 30 μm and 40 μm fixed by electrodeposit layer 126 which was Ni layer (Ni plate layer) was prepared.

2-2. Slicing of Group III Nitride Crystal Body

Referring to FIGS. 4 to 6, electrodeposit-fixed-abrasive wire 120 prepared in the above-described manner was used as saw wire 100 to slice the GaN crystal body (group III nitride crystal body 30) prepared in the above-described manner and thereby produce a GaN crystal substrate (group III nitride crystal substrate) of 4 inches in diameter and 600 μm in thickness.

The crystal body was sliced under the conditions that the wire feed was 3 m/min to 5 m/min, the constant high speed at which the wire ran was 400 m/min, the time for which the constant high speed was kept was 4.5 sec, the acceleration/deceleration time was 1.5 sec, the swing angle was 5°, the swing angular velocity was 350°/min, the tension on the wire was 35 N, and the rate at which the crystal body was sliced was 0.5 mm/hr to 6.0 mm/hr. In order to remove cutting chips and heat generated during slicing, the crystal body was sliced while a cutting fluid which was a mixture of a surfactant and water was jetted to the GaN crystal body (group III nitride crystal body) and the electrodeposit-fixed-abrasive wire.

A short time of approximately 27 hours was required for slicing one GaN crystal body (group III nitride crystal body). Arithmetic mean surface roughness Ra of the obtained GaN crystal substrate (group III nitride crystal substrate) was a large roughness of 0.3 μm to 0.9 μm in the direction perpendicular to the direction in which the wire ran and a large roughness of 0.2 μm to 0.5 μm in the direction parallel to the direction in which the wire ran. In both the direction perpendicular to the direction in which the wire ran and the direction parallel to the direction in which the wire ran, the warp of the GaN crystal substrate (group III nitride crystal substrate) was a relatively small warp of 45 μm. The yield of GaN crystal substrates (group III nitride crystal substrates) was a low yield of 60%. The results are summarized in Table 1.

TABLE 1

| | | | Comparative | Comparative | |
|---|---|---|---|---|---|
| | | | Example 1 | Example 2 | Example 1 |
| type of wire and type of abrasive | | | wire & loose | electrodeposit- | resin-fixed- |
| | | | abrasive | fixed-abrasive | abrasive |
| | | | | wire | wire |
| slice | wire feed (m/min) | | 8 to 10 | 3 to 5 | 5 to 20 |
| conditions | constant high speed of wire (m/min) | | 400 | 400 | 400 |
| | time for which constant high speed of | | 4.5 | 4.5 | 4.5 |
| | wire is kept (sec) | | | | |
| | wire acceleration/deceleration time (sec) | | 1.5 | 1.5 | 1.5 |
| | wire swing angle (°) | | 0.3 | 5 | 5 |
| | wire swing angular velocity (°/min) | | 100 | 350 | 350 |
| | tension on wire (N) | | 30 | 35 | 35 |
| | slicing rate (mm/hr) | | 0.5 to 2.0 | 0.5 to 6.0 | 0.5 to 6.0 |
| time for slicing (hrs) | | | about 160 | about 27 | about 27 |
| physical | arithmetic mean | direction | 0.2 to 0.3 | 0.3 to 0.9 | 0.2 to 0.35 |
| properties of | surface | perpendicular to wire | | | |
| substrate | roughness | direction parallel with | 0.2 to 0.3 | 0.2 to 0.5 | 0.2 to 0.35 |
| | Ra (μm) | wire | | | |
| | warp | direction | 75 | 45 | 30 |
| | (μm) | perpendicular to wire | | | |
| | | direction parallel with | 75 | 45 | 30 |
| | | wire | | | |

| | | | |
|---|---|---|---|
| yield (%) | 75 | 60 | 90 |

Referring to Table 1, it is seen from Comparative Example 1 that a problem in the case where a wire and a loose abrasive were used to slice a group III nitride crystal body was that a long time was taken for slicing, the warp of the obtained group III nitride substrate was large, and the yield thereof was low. It is also seen from Comparative Example 2 that a problem in the case where an electrodeposit-fixed-abrasive wire was used to slice a group III nitride crystal body was that arithmetic mean surface roughness Ra and the warp of the obtained group III nitride crystal substrate were large. In contrast, it is seen from Example 1 that in the case where a resin-fixed-abrasive wire was used to slice a group III nitride crystal body, a group III nitride crystal substrate with a small warp and a small arithmetic mean surface roughness Ra could be obtained in a short slicing time and with a high yield.

It should be noted that in the case where a sapphire crystal body is sliced with a resin-fixed-abrasive wire used as the saw wire, the wire feed is extremely large which is disadvantageous in terms of the cost. Therefore, an electrodeposit-fixed-abrasive wire is used for slicing a sapphire crystal body.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of manufacturing a group III nitride crystal substrate comprising the steps of:
preparing a group III nitride crystal body; and
producing a group III nitride crystal substrate by slicing said group III nitride crystal body with a resin-fixed-abrasive wire.

2. The method of manufacturing a group III nitride crystal substrate according to claim 1, wherein said group III nitride crystal substrate has a warp of 50 μm or less per 4 inches.

3. The method of manufacturing a group III nitride crystal substrate according to claim 1, wherein said group III nitride crystal substrate has an arithmetic mean surface roughness Ra of 0.5 μm or less.

4. The method of manufacturing a group III nitride crystal substrate according to claim 1, wherein yield of said group III nitride crystal substrates is 80% or more.
